(19) United States
(12) Patent Application Publication
(10) Pub. No.: US 2007/0216655 A1
(43) Pub. Date: Sep. 20, 2007

(54) Portable electronic device with switchable interfaces

(76) Inventors: Hsiang Chen, Taipei (TW); Po-Yeu Chiu, Taipei (TW)

Correspondence Address: HARNESS, DICKEY & PIERCE, P.L.C., P.O. BOX 8910, RESTON, VA, 20195, US

(21) Appl. No.: 11/375,014

(22) Filed: Mar. 15, 2006

(51) Int. Cl. G06F 3/041

(52) U.S. Cl. 345/173

(57) ABSTRACT

A portable electronic device with switchable interfaces is provided. The device comprises a body with a touch panel, and a plurality of panels which can be used alternatively. The body is disposed with a corresponding interface panel for displaying one of the plurality of user interfaces, thus an interface adaptable for users to operate can be provided depending on the requirements of the use situation. Moreover, the panel further comprises an identifying element for generating an identification signal when disposed in the body, such that the user interface can be switched and can display a state corresponding to the selected panel.

### BACKGROUND OF THE INVENTION

1. Field of Invention

The invention relates to a portable electronic device, and more particularly to a portable electronic device with switchable interfaces.

2. Related Art

Portable electronic devices, such as cell phones, digital cameras, digital video cameras, multimedia players, portable game machines, electronic dictionaries, personal digital assistant devices, global positioning systems, and audio-visual satellite navigation systems are becoming popular, and different devices are starting to be integrated with multiple functions. However, different use situations demand different user interfaces. For example, display and keyboard are used in cell phones, portable game machines, electronic dictionaries, digital cameras, digital video cameras, multimedia players, and the like, but the size of the display, the number of the keys, and the positions of the keys suitable for each device are not the same. For example, a cell phone has the display disposed above the keyboard and has keys numbering between ten and twenty, while a portable game machine has a display larger than that of the cell phone but has keys fewer than those of the cell phone and in a different arrangement. Further, the touch panel having functions of displaying and inputting is used in the personal digital assistant device, global positioning system, and audio-visual satellite navigation system. Therefore, it has become an important subject to maintain various user interfaces when integrating various functions of portable electronic devices, so as to provide preferable convenience for users.

Recently, some methods of switchable interfaces have been proposed. For example, ROC Utility Model Publication NO. M273137 published in 11 Aug. 2005 discloses a multimode key module, which employs a movement mechanism for dislocating the printed keyboard and the keyboard display lattice, such that the lattice corresponds to different key printed pictures, thus generating different key modules. Moreover, the movement mechanism is used to dislocate the key circuit board and the touch-control sensing plate, thus generating different touch panel key modules. The method can provide different key modules, but the arrangement and size of the display are not changed, and the movement mechanism is difficult to be implemented in the portable electronic device since the portable electronic device are required to have small volume. Besides, ROC Publication NO. 00573273 published in 21 Jan. 2004 discloses a user interface used in a plurality of electronic devices. The user interface is independent from each electronic device and remotely controls each electronic device with a wireless communication function. The touch panel on the user interface will receive and display the screen layout and content of the selected electronic device, thus achieving the function of switchable interfaces. However, in the situation that the touch panel is used in a portable game machine or cell phone, since the user is used to use keys, an inconvenience may arise. And the user interface independent of each electronic device is not adaptable in portable electronic devices.

### SUMMARY OF THE INVENTION

A main object of the present invention is to provide a portable electronic device with switchable interfaces, to solve the problems existing in the prior art.

Therefore, in order to achieve the above object, a portable electronic device with switchable interfaces disclosed in the present invention has a body provided with a touch panel. The touch panel has a plurality of switchable user interfaces each of which has a key-in area and display area with different layouts respectively in order to be compatible with different use situations. Furthermore, the portable electronic device further comprises a plurality of alternative panels for covering the touch panel. Each of the alternative panels corresponds to a user interface one-to-one, and has a key area and a window area. The window area responds to the display area for observing pictures and information during operation. And the key corresponds to the key-in area for inputting operational instructions from the panel via the touch panel. Moreover, in order to improve the convenience of switching interfaces, the above panel can be additionally provided with an identifying element. And the body has a determining element for receiving the identifying element, thus when the panel covers the touch panel, a switch signal can be provided for switching to the user interface corresponding to the panel.

To sum up, with the technical means of the present invention, the problems of the conventional technique can be solved efficiently. And an interface facilitating the users' operation can be provided depending on the requirement of the using situation, thus it has characteristics of industrial application, innovation, and progress. The features and practices related to the present invention will be described in detail through the preferred embodiment accompanied with drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and which thus is not limitative of the present invention, and wherein:

FIG. 1 is a structural diagram of a first embodiment of the present invention;

FIG. 2A and FIG. 2B are schematic views of the implementation of the first embodiment of the present invention;

FIG. 3A and FIG. 3B are diagrams of a second embodiment of the present invention;

FIG. 4A and FIG. 4D are diagrams of a third embodiment of the present invention;

FIG. 5A and FIG. 5D are diagrams of a fourth embodiment of the present invention;

FIG. 6 is a diagram of a fifth embodiment of the present invention; and

FIG. 7 is a diagram of a sixth embodiment of the present invention.

### DETAILED DESCRIPTION OF THE INVENTION

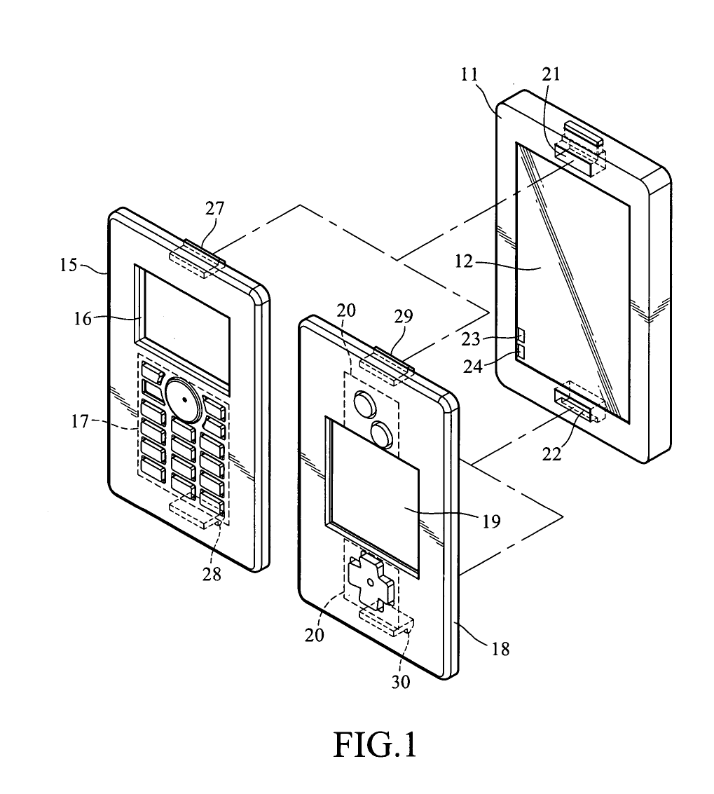

Referring to FIG. 1, it shows a diagram of a first embodiment of the present invention, and the structure thereof comprises a body 11 of the portable electronic device, a touch panel 12 on the body, and a plurality of panels for covering the touch panel 12 respectively (for example, two panels 15, 18 in the drawing, but the present invention is not limited to the two panels 15, 18). The touch panel 12 has a plurality of switchable user interfaces (not shown).

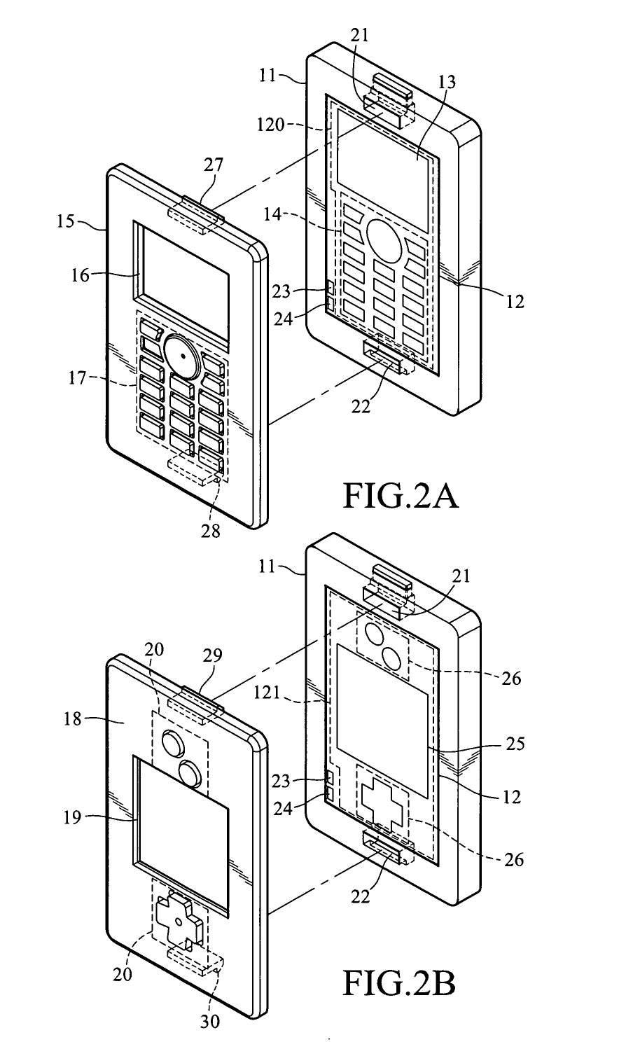

Then, referring to FIG. 2A and FIG. 2B, the implementation of the first embodiment is described in detail. As shown in the drawings, the body 11 has grooves 21, 22, and the panel 15 has hooks 27, 28, and the panel 18 has hooks 29, 30. The hooks 27, 28 or 29, 30 are embedded in the grooves 21, 22 in corresponding positions when the panel 15 or the panel 18 covers the body 11 respectively. The panel 15 has a window area 16 and a key area 17, and the other panel 18 has a window area 19 and a key area 20. In the first embodiment, only user interfaces 120, 121 corresponding to the above panels 15, 18 are illustrated; however, the present invention is not limited to the two user interfaces 120, 121. The user interface 120 has a display area 13 and a key-in area 14, and the other user interface 121 has a display area 25 and a key-in area 26. After the panel 15 or 18 covers the body 11, the window area 16 or 19 thereof just covers the corresponding display area 13 or 25, for observing the pictures and information during operation. At the same time, the key area 17 or 20 covers the corresponding key-in area 14 or 26, such that when the user presses the key area 17 or 20 of the panel 15 or 18, an operational instruction is input through the touch panel. Moreover, the touch panel 12 further comprises a plurality of switching keys. When pressing the switching keys, the user interfaces can be switched. The switching keys 23, 24 are illustrated in the present invention; however, the present invention is not limited in the two switching keys 23, 24. The switching keys 23, 24 correspond to the user interfaces 120, 121 respectively. When the switching key 23 is pressed, the touch panel 12 will display the user interface 120, as shown in FIG. 2A, in which the cell phone interface arrangement is illustrated. When the switching key 24 is pressed, the touch panel 12 will display the user interface 121, as shown in FIG. 2B, in which the portable game machine interface arrangement is illustrated.

When the touch panel 12 displays the user interface 120, as shown in FIG. 2A, the hooks 27, 28 are embedded in the grooves 21, 22 respectively, such that the panel 15 covers the touch panel 12, and after covering, the window area 16 covers the display area 13, and the key area 17 covers the key-in area 14. At this time, the key area 17 provide an operation mode suitable for inputting with keys under the situation of using a cell phone is used, and the size and position of the display provided by the window area 16 can be adapted to the requirements of the cell phone.

After taking off the panel 15 on the touch panel 12, switching keys 24 are used to make the touch panel 12 display the user interfaces 121, as shown in FIG. 2B. At this time, the panel 18 is selected, and the hooks 29, 30 are embedded in the grooves 21, 22 respectively, such that the panel 18 covers the touch panel 12. After covering, the window area 19 covers the display area 25, and the key area 20 covers the key-in area 26, at this time, the key area 20 provides a key operation and key arrangement mode suitable for the situation of using the portable game machine. And the display of the window area 19 is not only large, but also is located in a suitable position meeting the requirements of the portable game machine.

If the panel 18 of the touch panel 12 is taken off, the switching key 23 is used to switch the user interface to the user interface 120. At this time, the panel 15 covers the touch panel 12, and the device is suitable for the situation of cell phone again. According to the above method, interfaces of the portable electronic devices can be switched, thus providing operational convenience for the user, and avoiding the problem that some functions are abandoned when integrating various functions together.

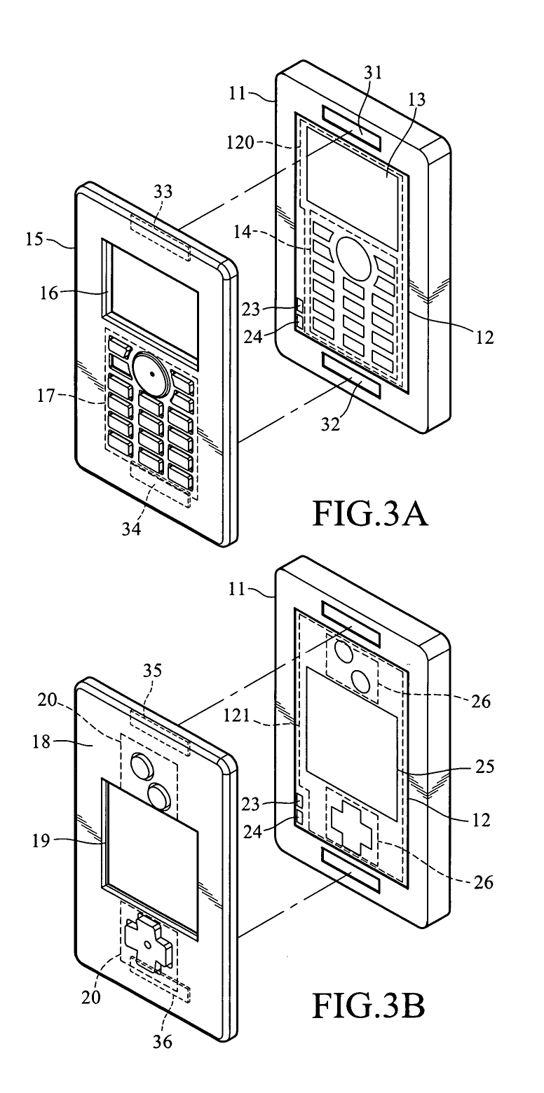

The way of covering can be changed depending on the requirement of implementation, which will be described in a second embodiment. As shown in FIG. 3A and FIG. 3B, the body 11 has alloy iron plates 31, 32. The panel 15 has magnet plates 33, 34. And the panel 18 has magnet plates 35, 36. The switching key 23 is used to switch the user interface to the user interface 120, as shown in FIG. 3A, and the corresponding panel 15 is selected. Then the magnet plates 33, 34 attract the alloy iron plates 31, 32 and are attached to them respectively, such that the panel 15 covers the touch panel 12. If the user interface is desired to be switched, the panel 15 on the touch panel 12 is taken off, and the switching key 24 is used to switch the user interface to the user interface 121, as shown in FIG. 3B. At this time, the panel 18 is selected, and the magnet plates 35, 36 attract the alloy iron plates 31, 32 and are attached to them respectively, such that the panel 18 covers the touch panel 12.

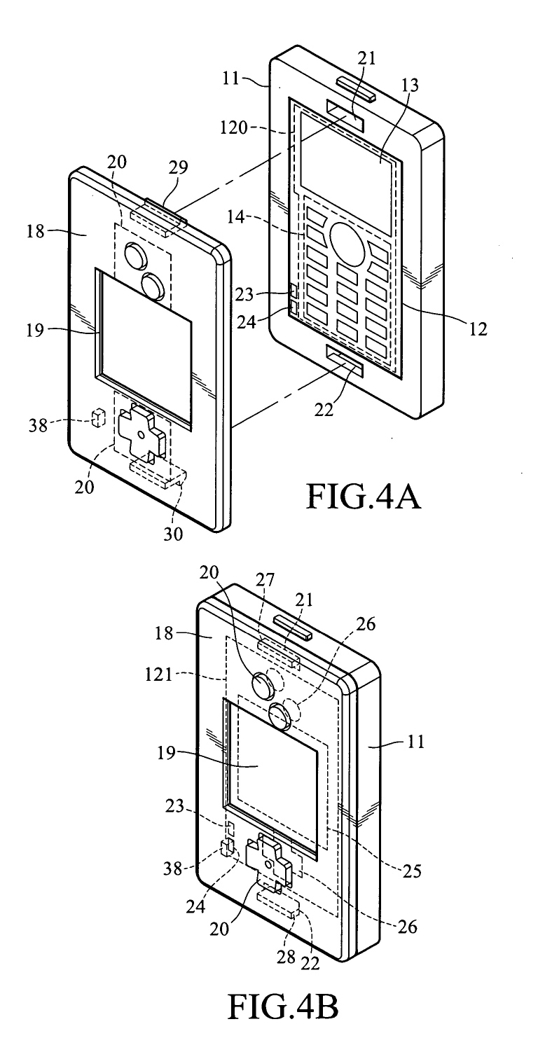

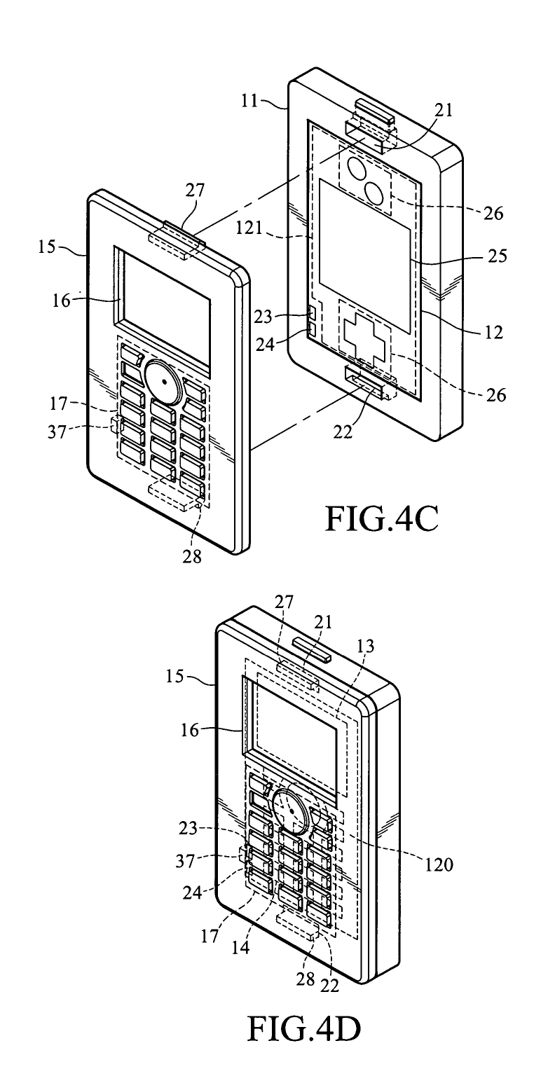

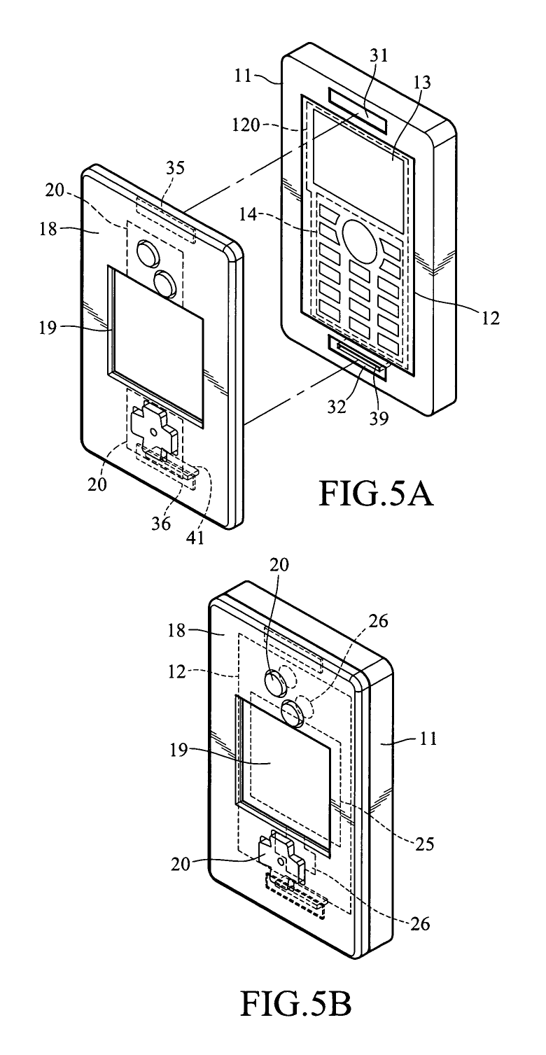

Moreover, in order to enhance the convenience of switching interfaces, the above panel can be further provided with an identifying element, and the body has a determining element for receiving the identifying element. After the panel covers the touch panel, a switch signal can be provided, for switching the user interface to the corresponding one of the panel, which is illustrated in a third embodiment herein. Referring to FIG. 4A and FIG. 4D, the panels 15, 18 of the first embodiment are provided with bumps 37, 38 for identification. The bump 37 corresponds to the switching key 23, and the bump 38 corresponds to the switching key 24. When the touch panel 12 displays the user interface 120, the panel 18 not corresponding to the touch panel 12 is selected, as shown in FIG. 4A. The hooks 29, 30 are embedded in the grooves 21, 22 respectively, such that the panel 18 covers the touch panel 12. At the same time, the bump 38 presses the switching key 24, switching the user interface to the user interface 121. After covering and switching, the window area 19 covers the display area 25, and the key area 20 covers the key-in area 26, as shown in FIG. 4B. When the user interface is desired to be switched, the panel 18 is taken off at first. At this time, the touch panel 12 displays the user interface 121, and the panel 15 not corresponding to the touch panel 12 is selected, as shown in FIG. 4C. The hooks 27, 28 are embedded in the grooves 21, 22 respectively, such that the panel 15 covers the touch panel 12. At the same time, the bump 37 presses the switching key 23, switching the user interface to the user interface 120. After covering and switching, the window area 16 covers the display area 13, and the key area 17 covers the key-in area 14, as shown in FIG. 4D. According to this identification method, it is convenient for the user to finish switching interfaces just by closing the panel, without selecting the user interface on the touch panel in advance, which is helpful for reducing the complexity of the switching.

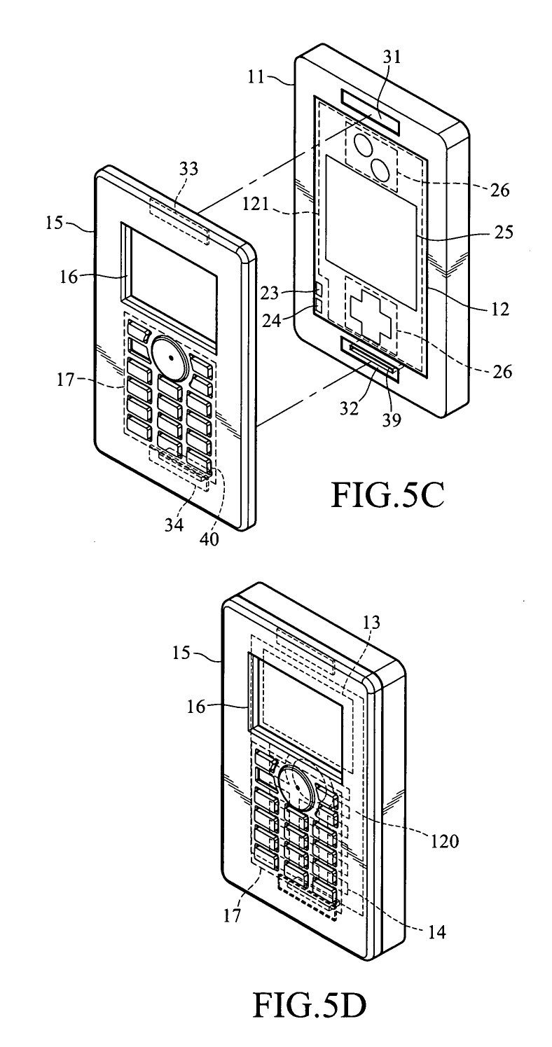

The identification method can be changed depending on the requirement of the implementation, which will be described in a fourth embodiment herein. Referring to FIG. 5A to FIG. 5D, a chip slot 39 is built in the alloy iron plate 32 of the second embodiment, and chips 40, 41 are embedded in the magnet plates 34, 36 respectively. When the touch panel 12 displays the user interface 120, the panel 18 not corresponding to the touch panel 12 is selected, as shown in FIG. 5A. The magnet plate 35, 36 attract the alloy iron plates 31, 32 and are attached to them respectively, such that the panel 18 covers the touch panel 12. At this time, the chip 41 is inserted in the slot 39, for providing a switch signal to switch the user interface to the user interface 121. After covering and switching, the window area 19 covers the display area 25, and the key area 20 covers the key-in area 26, as shown in FIG. 5B. If the user interface is desired to be switched, the panel 18 on the touch panel 12 is taken off at first. At this time, the touch panel 12 displays the user interface 121, and the panel 15 not corresponding to the touch panel 12 is selected, as shown in FIG. 5C. The magnet plates 33, 34 attract the alloy iron plates 31, 32 and are attached to them respectively, such that the panel 15 covers the touch panel 12. At this time, the chip 40 is inserted in the slot 39, for providing a switch signal to switch the user interface to the user interface 120. After covering and switching, the window area 16 covers the display area 13, and the key area 17 covers the key-in area 14, as shown in FIG. 5D. According to the identification method, the different chips on the panels are used to determine and switch the user interfaces corresponding to the different panels, without using the switching keys on the touch panel as the medium.

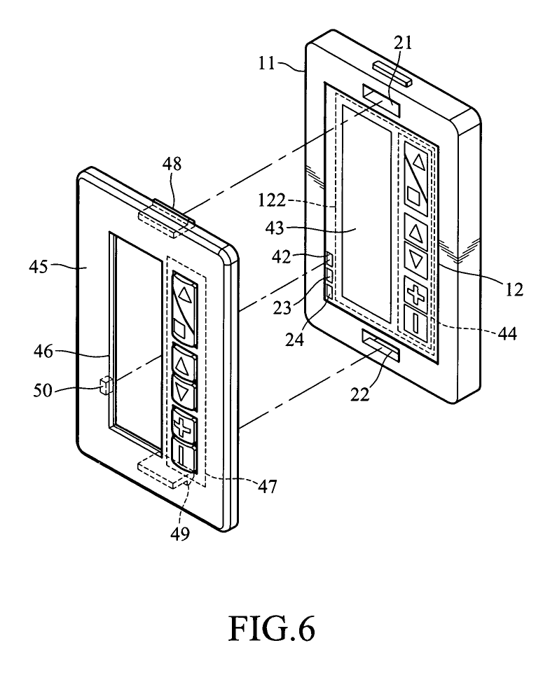

The above implementation can be further used in switching more than two interfaces, which is described in a fifth embodiment herein. Referring to FIG. 6, the touch panel 12 has a switching key 42. When pressing the switching key 42, the touch panel 12 displays a user interface 122 (the interface arrangement of a multimedia player is illustrated in the drawing). The user interface 122 corresponds to a panel 45, and the panel 45 has a window area 46 and a key area 47, while the user interface 122 has a display area 43 and a key-in area 44. Moreover, the panel 45 has hooks 48, 49 for being embedded in the grooves 21, 22, such that the panel 45 covers the touch panel 12. After covering, the window area 46 covers the display area 43, and the key area 47 covers the key-in area 44. Besides, when the touch panel 12 displays the user interface 120 or 121, referring to FIG. 2A and FIG. 2B, the panel 45 is further provided with a bump 50 used as an identifying element. The bump 50 presses the switching key 42 when covering, so as to switch the user interface to the user interface 122. In view of the above embodiments, more than two switchable interfaces can be successfully provided in a portable electronic device.

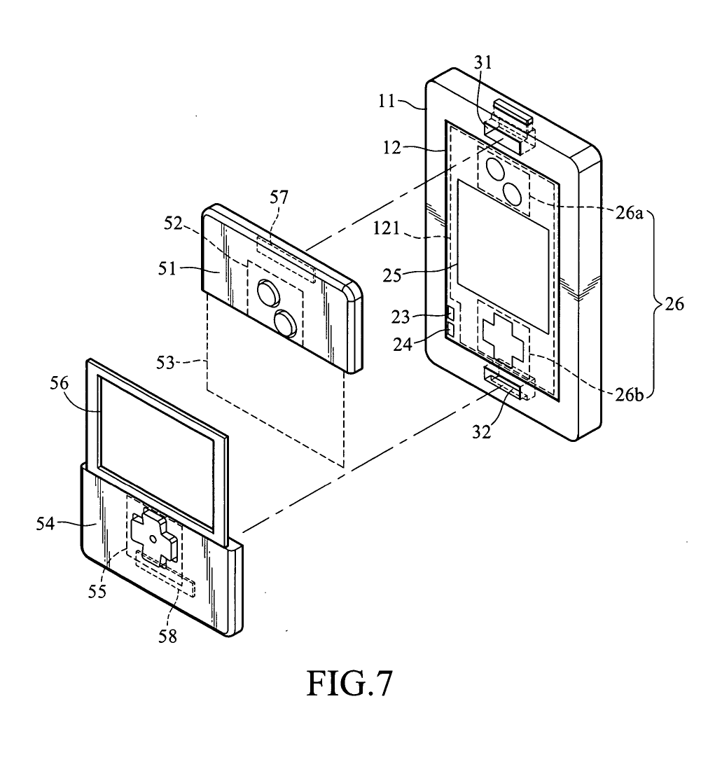

Further, the panel of the invention needs not to cover the whole touch panel, and has a hollow or an empty window area. Therefore, more than one panel can cover the touch panel simultaneously, which is described in a sixth embodiment herein. As shown in FIG. 7, a panel 51 has a key area 52 and an empty window area 53, and a panel 54 has a key area 55 and a hollow window area 56. The key area 52 corresponds to the key-in area 26a, and the key area 55 corresponds to the key-in area 26b. The panels 51, 54 are further provided with magnet plates 57, 58 respectively. The magnet plates 57 attracts and is attached to the alloy iron plate 31, such that the panel 51 covers the touch panel 12, allowing the key area 52 cover the key-in area 26a. And the magnet plate 58 attracts and is attached to the alloy iron plate 32, such that the panel 54 covers the touch panel 12, allowing the key area 55 cover the key-in area 26b. The empty window area 53 and the hollow window area 56 only with a frame allow the display area 25 directly used as the display.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable electronic device with switchable interfaces, comprising:
a body with a touch panel which has a plurality of switchable user interfaces, each of the switchable user interfaces having at least one key-in area and at least one display area, and the layouts of the key-in area and the display area of the user interfaces being different from each other; and
a plurality of alternative panels, for covering the touch panel, the alternative panels including at least one key area and at least one window area, the layouts of the key area and the window area of the panels being different from each other, and the panels corresponding to the user interfaces respectively, thus making the window area correspond to the display area and making the key area correspond to the key-in area.

2. The portable electronic device with switchable interfaces as claimed in claim 1, wherein the window area is a hollow window area.

3. The portable electronic device with switchable interfaces as claimed in claim 1, wherein the panels have at least one hook, and the body has at least one groove, the hook catching the groove when the panel covers the body.

4. The portable electronic device with switchable interfaces as claimed in claim 1, wherein the panels have at least one magnet, and the body has at least one magnetic substance, the magnet attracting the magnetic substance when the panel covers the body.

5. The portable electronic device with switchable interfaces as claimed in claim 1, wherein the panels have at least one identifying element, and the body has at least one determining element, the determining element determining the identifying element after the panel covers the touch panel, thus switching the touch panel to the user interface corresponding to the panel.

6. The portable electronic device with switchable interfaces as claimed in claim 5, wherein the identifying element is a bump, and the determining element is a button, the bump pressing the button after the panel covers the touch panel, thus switching the touch panel to the user interface corresponding to the panel.

7. The portable electronic device with switchable interfaces as claimed in claim 5, wherein the identifying element is a chip, and the determining element is a slot, the chip being inserted into the slot after the panel covers the touch panel, thus switching the touch panel to the user interface corresponding to the panel.

8. A portable electronic device with switchable interfaces, comprising a body with a touch panel which has a plurality of switchable user interfaces, each of the switchable user interfaces having at least one key-in area and at least one display area, and the layouts of the key-in area and the display area of the user interfaces being different from each other, and the touch panel further having a plurality of switching keys corresponding to the user interfaces one to one for switching the user interfaces.

9. The portable electronic device with switchable interfaces as claimed in claim 8, further comprising a plurality of alternative panels for covering the touch panel, each of the alternative panels having at least one key area and at least one window area, and the layouts of the key area and the window area of the panels being different from each other, and the panels corresponding to the user interfaces, thus making the window area correspond to the display area, and making the key area correspond to the key-in area.

10. The portable electronic device with switchable interfaces as claimed in claim 9, wherein the panels have at least one identifying element, and the body has at least one determining element, the determining element determining the identifying element after the panel covers the touch panel, thus switching the touch panel to the user interface corresponding to the panel.
